(19) United States
(12) Patent Application Publication
(10) Pub. No.: US 2025/0270838 A1
(43) Pub. Date: Aug. 28, 2025

(54) TEMPORARY STRUCTURE LEG WEIGHT SYSTEM

(71) Applicant: Burro LLC, New Paltz, NY (US)

(72) Inventors: Jacob Koenig, New Paltz, NY (US); Anthony Joseph Smith, Ithaca, NY (US)

(21) Appl. No.: 19/059,570

(22) Filed: Feb. 21, 2025

Related U.S. Application Data
(60) Provisional application No. 63/556,618, filed on Feb. 22, 2024.

(51) Int. Cl. E04H 12/22; F16M 13/02

(52) U.S. Cl. CPC E04H 12/2246; F16M 13/022

(57) ABSTRACT

Disclosed herein is a novel approach to easily and securely affix a leg weight to the leg of a temporary structure, making setup and breakdown of a temporary structure easier and the structure more securely anchored than many other solutions. The approach can also be used to secure objects to vertical posts and other structures.

### PRIORITY CLAIM

The present application claims the benefit of U.S. Provisional Application No. 63/556,618 filed Feb. 22, 2024, which is hereby incorporated by reference herein.

### TECHNICAL FIELD

The present disclosure is generally directed to temporary structures, such as popup canopy tents, and more specifically, to securing said structures to the ground.

### BACKGROUND

Temporary structures, such as popup canopy tents, generally require additional infrastructure to secure them to the ground, for example, either stakes into the ground or weights that attach to the structure, the latter commonly called leg weights. For leg weights, prior art generally utilizes a hook and loop fastener (i.e., Velcro®) to adhere to a vertical leg of a structure and/or the weight sits on a foot or a horizontal component of the structure that's flat on or near to the ground. Additional methods include tying rope or straps to various parts of the structure and attaching the other end of the rope or strap to a weight that is sitting on the ground.

### SUMMARY

Disclosed herein is a novel approach to easily and securely affix a leg weight to the leg of a temporary structure, making setup and breakdown of a temporary structure easier and the structure more securely anchored than many other solutions. The approach can also be used to secure objects to vertical posts and other structures.

In embodiments, systems disclosed herein utilize friction between the grips on a leg weight and the leg of a temporary structure to affix the leg weight to the structure for the purposes of securing the structure to the ground. This provides an easy to use and secure method of weighing down the structure.

In an embodiment, a system for securing or suspending objects from a vertical post or structural leg of a structure can include a clamp comprising an outer grip and an inner grip defining a space therebetween sized to accommodate the vertical post or structural leg. The clamp can be configured to grip the vertical post or structural leg by creating frictional contact through applied torque. A weight can be configured to be connected to the clamp to generate the torque on the clamp necessary for the clamp to grip the vertical post or structural leg.

In an embodiment, leg weight system for securing a temporary structure to the ground, can include a weight configured to apply a downward force and a clamp comprising an outer grip and an inner grip defining a space therebetween sized to accommodate a structural leg of the temporary structure. The clamp can be configured to grip the structural leg of the temporary structure by creating frictional contact through torque applied by the downward force of the weight. The weight can be configured to anchor the temporary structure by applying torque through the clamp to provide the downward force to the structural leg.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 depicts a leg weight according to an embodiment of the disclosure.

FIG. 2 depicts the leg weight of FIG. 1 affixed to the leg of a temporary structure.

FIG. 3 depicts a front view of the leg weight of FIG. 1 angled as required to mount it to the leg of the temporary structure.

FIG. 4 depicts a front view of the leg weight of FIG. 1 sitting in a mounted position.

FIG. 5 depicts a clamp attached to a leg of a temporary structure according to an embodiment of the disclosure.

FIG. 6 depicts a leg weight affixed to a leg of a temporary structure according to an embodiment of the disclosure.

FIG. 7 depicts a wire form according to an embodiment of the disclosure.

FIG. 8 depicts a wire form according to an embodiment of the disclosure.

FIG. 9 depicts a multi-part clamp according to an embodiment of the disclosure.

FIG. 10 depicts an open roll-top bag with modified D-rings and a separated handle, according to an embodiment in the disclosure.

FIG. 11 depicts the top of a closed rolltop bag with modified D-rings and a separated handle according to an embodiment in the disclosure.

FIG. 12 depicts a front view of the closed rolltop bag with modified D-rings and a separated handle of FIG. 11

FIG. 13 depicts the top of a closed rolltop bag connected to the handle via the modified D-rings according to an embodiment in the disclosure.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

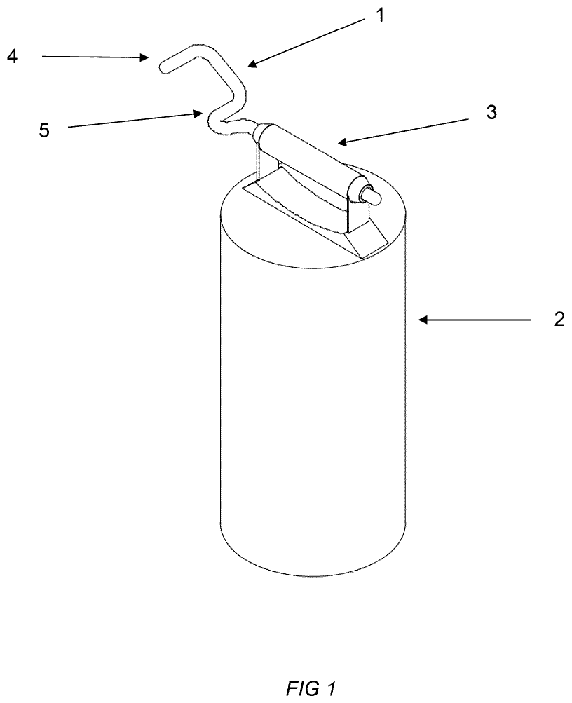

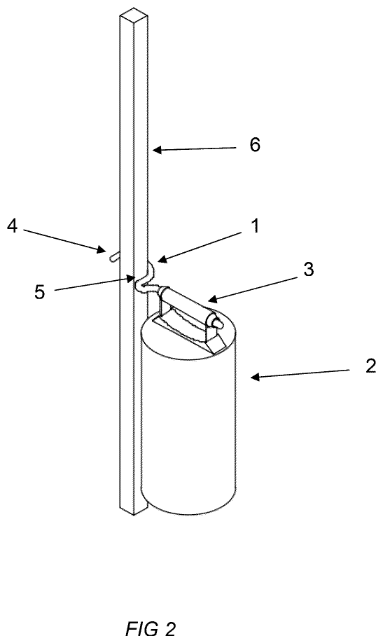

Referring now to FIGS. 1-4, a clamp 1 according to an embodiment of the disclosure is depicted. The clamp 1 is the component that grips the leg 6 of the temporary structure (not depicted), comprising an outer grip 4 and inner grip 5 that are placed on opposing sides of the leg 6. When a proper amount of torque is placed on the clamp 1, the grips 4,5 pinch the leg 6 with sufficient strength such that the clamp 1 stays in place on the leg 6. The weight 2 is the component that provides the force required to both create the requisite torque on the clamp 1 as well as the downward force required to help keep the temporary structure grounded. The clamp 1 and the weight 2 are secured together prior to placing the clamp 1 on the leg 6 of the temporary structure to ensure the weight 2 applies the required torque to the clamp 1 and the clamp 1 thusly applies the downward force to the leg 6 of the structure. In various embodiments, the clamp 1 and weight 2 could be permanently attached or detachable for storage when not in use, but the weight 2 generally is attached to the clamp 1 prior to attaching the clamp 1 to the leg 6_to provide a downward force on the clamp 1 when in use. In other embodiments, the clamp 1 may be able to be first placed on the leg 6 and the weight 2 subsequently attached to the clamp 1.

In various embodiments, there are many different ways by which the clamp 1 can attach to the weight 2. In one embodiment, the clamp 1 is connected to a handle 3 for the weight 2. This handle 3 serves as an easy way to both carry the weight 2 as well as manipulate the clamp 1 for mounting and dismounting. This provides a convenient portable system that integrates the clamp 1 and the weight 2 into a unitary and easily transportable system rather than requiring several components to be stored, transported, etc. There are additional embodiments in which the clamp 1 is connected directly to the weight 2 and any handles for the weight 2 are not integrated to the clamp 1 and weight 2. In other embodiments, clamp 1 can be indirectly connected to weight 2 by various other means.

The weight 2 could be a container, either made of a malleable or a hard shell, that requires a person to fill it with a substance, such as water, sand or concrete to create a sufficient amount of weight. The weight 2 could also be a self-contained weight, such as a piece of steel or other heavy material.

One embodiment of the weight 2 utilizes a roll top bag having a top that can be rolled down to modify a volume of the bag. This enables compressibility on a range of fill-levels. For example, the top can be rolled down to be compact with 25 lbs. of sand or it can be rolled down to be compact with 40 lbs. of sand. In another embodiment, a weight can comprise discrete modular sections that are selectively attachable to each other to provide a variable torque for securing a temporary structure against variable environmental forces such as wind.

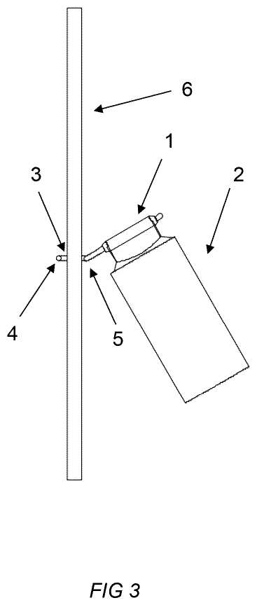

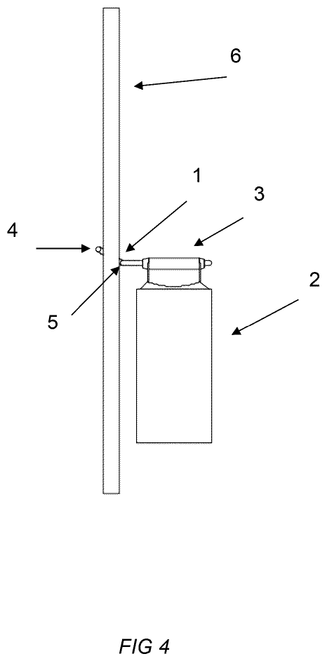

The clamp 1 can be composed primarily of two grips, an outer grip 4, and an inner grip 5, connected together. The outer grip 4 and the inner grip 5 protrude from their connection parallel to each other, such that they can be positioned on either side of a structure's leg 6. The clamp 1 is initially positioned such that the outer grip 4 and the inner grip 5 are on opposing sides of the leg 6 and with the connection between grips 4,5 being generally parallel to the ground and the weight 2 attached to the clamp 1, each grip 4,5 being roughly equidistant to the ground as shown in FIG. 3. Once the clamp 1 is so positioned, releasing the weight 2 will create a rotational force on the clamp 1 generated by the weight 2 that translates to the clamp 1 pinching the leg 6, thus creating sufficient friction between the leg 6 and the grips 4,5 such that the weight 2 stays in place in a fixed position relative to the leg 6, elevated above the ground and attached only to the leg 6 of the structure via the clamp 1. This mechanism ensures a continual downward force is applied to the leg 6 of the structure and does not require a reliance on a horizontal component of the structure or strapping to other parts of the structure. There is also no need to first attempt to manually position the clamp 1 and then separately attach the weight 2. In this configuration, as shown in FIG. 4, the grips 4, 5 may be angled relative to each other (i.e. grip 4 is higher than grip 5 along the length of the leg 6) with the connection between the grips 4, 5 also angled relative the ground. The handle 3 and the bottom of the weight 2 may now be parallel with the ground. The weight 2 therefore applies a force in the desired direction downward on the leg 6.

In embodiments, the functionality of the clamp 1 can be improved when the surface of the grips 4,5 have a relatively high friction coefficient, such as a rubber sleeve or a rubberized coating, to ensure that they do not slide on the leg 6 of the structure but instead grip it. In various embodiments the grips 4,5 could be simple cylindrical knobs, but they could also have a longer flat side that grips the leg 6 to disperse the weight over a larger surface area of the leg 6.

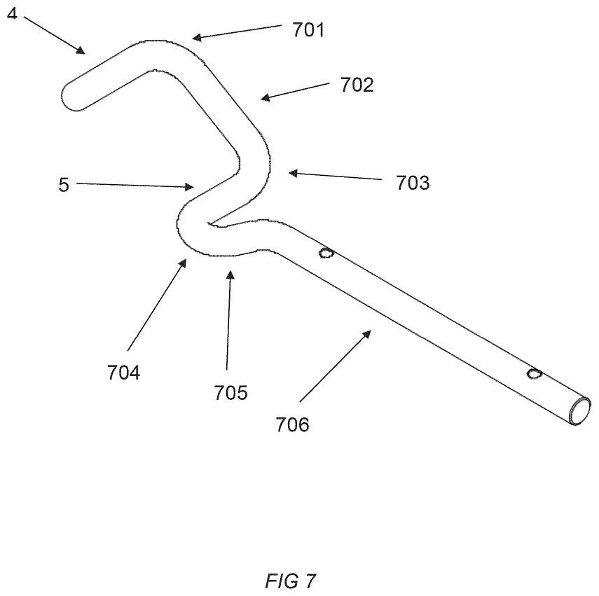

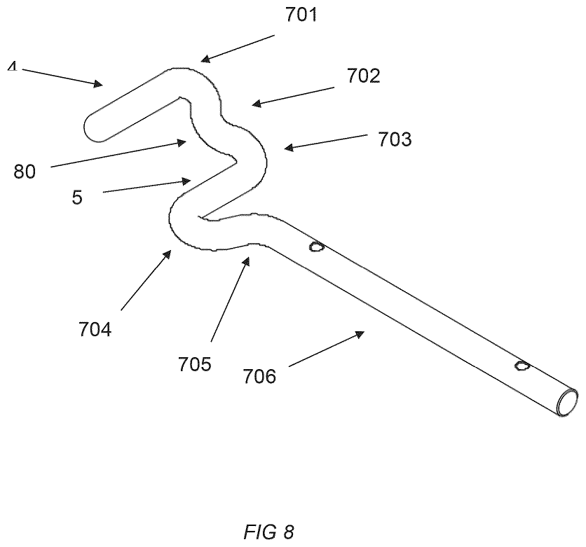

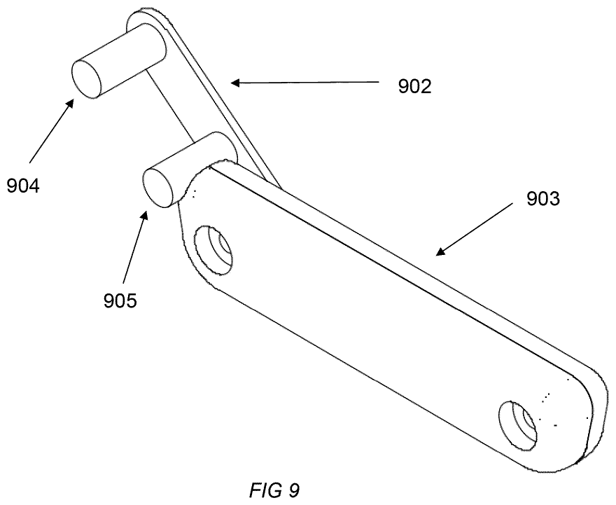

In various embodiments, clamp 1 can be formed and/or configured in a multitude of ways. One embodiment, as illustrated in FIG. 7 and FIG. 8, uses a single piece of bent rod, aka wire form, to form the outer grip 4, then bends at bend 701 to create the connecting component 702 between the grips 4, 5 with another bend 703 to create the inner grip 5, and then 2 more bends 704, 705 to center the clamp with the weight 2, and run the length of the handle 706. This embodiment minimizes the number of components. The wire form extension through the length of the handle 706 can also include a pair of apertures 708 extending through the wire form used for attaching a more ergonomic handhold over the wire form itself, as pictured in FIGS. 1-4. One embodiment, as illustrated in FIG. 8, contains an additional bend 800 on the connecting component 702 to serve as a touch point to the side of the leg when mounting, thus avoiding the corners of the leg from abrading the inner corners of the bends 701 and 703. Another embodiment, as illustrated in FIG. 9, can use different pieces for the outer grip 904, inner grip 905, and the piece 902 that connects the two grips to form a clamp comprising multiple parts.

Clamp 1 can be provided in multitude of sizes and/or configurations to accommodate different sized and/or shaped legs 6. If using a single component for the entirety of the clamp 1, different clamps 1 can be designed with differing dimensions to accommodate the most common leg dimensions. Alternatively, the component may be capable of being adjusted by a user to accommodate different leg dimensions. As depicted in FIG. 9, if the outer grip 904 and inner grip 905 are connected with a separate component 902, the connecting component 902 between the two grips 904, 905 could be adjustable in length and/or one or more of the grips 904, 905 may be movable with respect to the connecting component 902 and/or each other. Another embodiment could utilize replaceable grips 904, 905 with different diameters, effectively adjusting the distance between the grips 904, 905 because larger grips will have a smaller space therebetween and smaller grips will have a greater space. Yet another embodiment could use an insert that can be attached to one of the grips and/or inserted in between the grips, effectively reducing the distance between the grips 4,5. Separate component 902 may include a pair of apertures 908 therethrough that can aid in connecting component 902 to a weight or other item.

Referring now to FIG. 3-4, the placement of the outer grip 4 and inner grip 5 according to an embodiment of the disclosure is depicted to demonstrate positioning of the grips 4,5 with respect to each other for the purposes of a desired mounting and dismounting experience. One embodiment of clamp 1 includes the outer grip 4 being higher than the inner grip 5 when the handle 3 is in a horizontal position. This requires the user to lift the handle 3, as depicted in FIG. 3, prior to mounting the clamp 1, such that the grips 4, 5 are an equal height from the ground and the weight 2 is attached to the clamp 1 when initially placing the clamp 1 on the leg 6 as described above. When the user then subsequently releases the handle 3, the weight 2 causes the handle 3 to rotate down such that the clamp 1 grips the leg 6 upon returning to its original state with the handle 3 approximately horizontal, as depicted in FIG. 4, at which point the weight 2 is secured to the leg 6 of the structure and the outer grip 4 is once again higher than the inner grip 5.

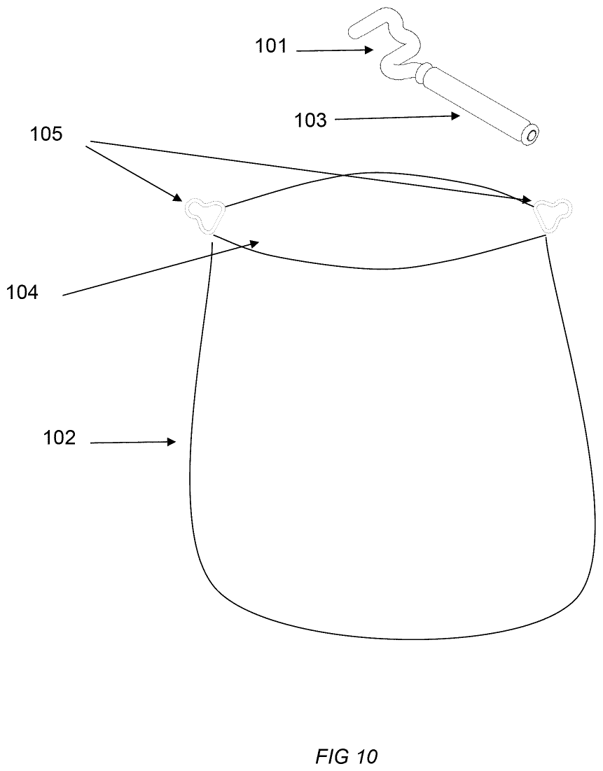

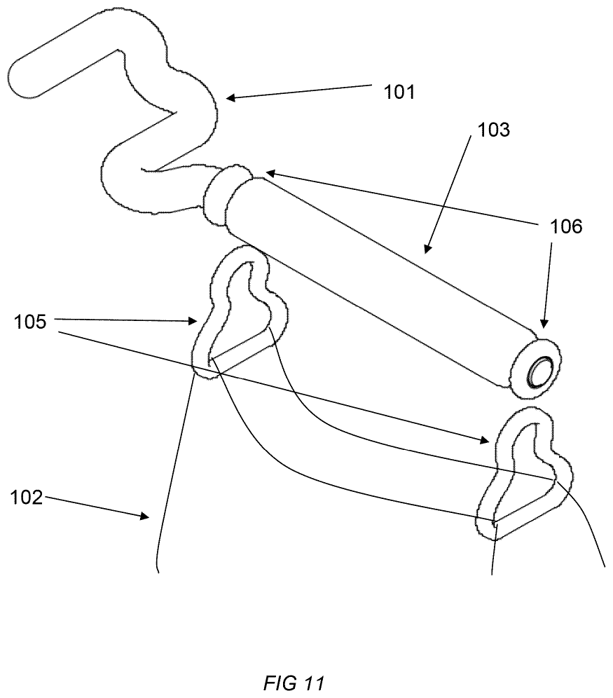

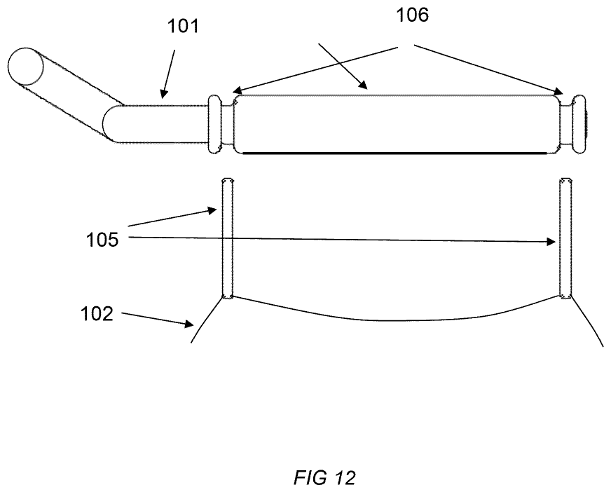

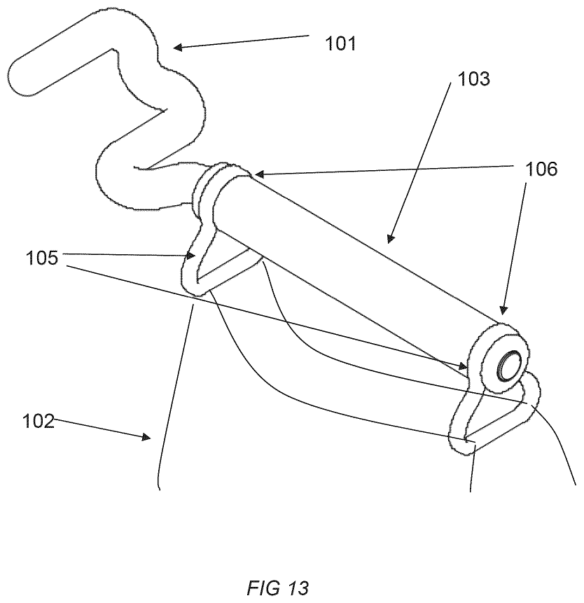

In various embodiments, a weight can attach to a handle and a wire form/clamp in various ways, such as ropes, release buckles, hooks or clips. Referring now to FIGS. 10-13, in one embodiment the weight 102 can integrate modified D-rings 105 designed to connect to the handle 103 with the handle 103 serving to join the wire form clamp 101 to the weight 102. In this embodiment, instead of using side-release buckles at the opening 104 of a rolltop bag 102, as is common, modified D-rings 105 are sewn into the top of the bag 102 as depicted in FIG. 10. The modified D-rings 105 are designed to fit into grooves 106 in the handle 103, which is secured to the wire form 101. The modified D-rings 105 are sized to click into the grooves 106 in the handle 103, such that it requires some force to press the modified D-rings 105 into place, and once they are clicked into place, as depicted in FIG. 13, they again require force to detach them from the handle 103, therefore serving to keep the rolltop bag 102 closed as well has attach the bag 102 to the handle 103. The handle 103 can be secured to the wire form handle 101 as an overmold, or as a distinct part connected with fasteners, push-pins, or a friction-fit around the wire form 101.

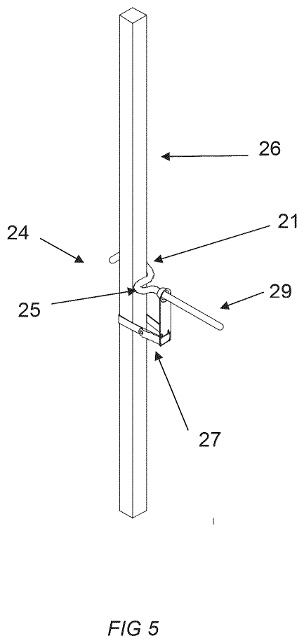

Referring now to FIG. 5, a clamp 21 according to an embodiment of the disclosure is depicted in which an additional component supplements the torque on the clamp if there is not sufficient weight present to create the required amount of torque on its own. This embodiment uses a tensioned loop 27, such as a stretchable rubber loop, attached below the clamp 21, which, when sufficiently taut, will create a sufficiently strong torque on the clamp 21 to grip the leg 26. This might be used to hang lighter products from the end 29 of clamp 21, such as a sign or awning that do not on their own create sufficient torque on the clamp 21. This embodiment could also be used solely for the purpose of hanging such an item on a vertical post, which would be applicable to various other structures other than temporary structures requiring an anchoring weight.

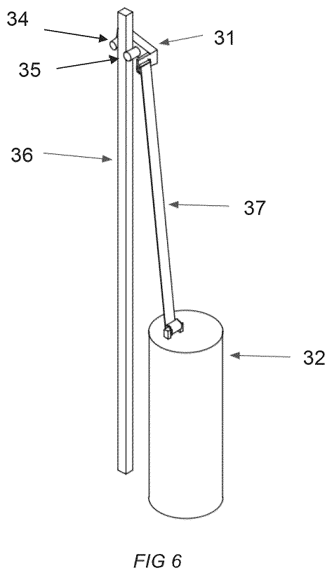

Referring now to FIG. 6, a clamp 31 according to an embodiment of the disclosure is depicted allowing for an adjustable length connection 37 between the clamp 31 and the weight 32. There are times in which it is desired to anchor to the structure at a higher point off the ground. The same friction clamping mechanism 31 could be used but would not be rigidly attached to the weight 32, but instead is attached to the weight 32 with an adjustable strap 37. In the instance that a user may want to attach higher to the leg 36 of a structure, that strap 37 could be used to connect the weight 32 and the clamp 31. By creating tension in the rope or strap 37 as can be done with a ratchet or other tensioning method, the strap 37 will provide enough downward force to create sufficient friction between the grips 34,35 and the leg 36 such that the clamp 31 stays in place and provides the desired anchoring force at a higher point on the leg 36 (provided the weight 32 is heavy enough).

In embodiments, temporary structures such as popup canopy tents disclosed herein can include an integrated electrical system. Electronic systems are frequently needed to provide light or charge electronic devices, for example. Prior art generally treats these systems as separate and requires additional setup. The aim of this integrated electric system is to provide an electric system that is built into a temporary structure, requiring minimal additional work when erecting or collapsing the structure.

The electrical system can consist of a battery, wires, standard ports, and custom ports. The system does not require full disassembly/assembly each time the structure is collapsed/erected for transport, such as how popup canopies collapse. This requires minimal additional work from the user when erecting or taking down the structure.

In embodiments, the wires can be either sewn into the cloth canopy of the structure, wired through hollow beams of the structure, or affixed otherwise to ensure they are integrated into the structure and not hanging loose. The wires could also be sewn into separate strips of fabric that are then affixed to the structure or the canopy roof fabric. The wires serve to connect the battery to the other components.

The battery can be removable such that it can be charged and/or used separately from the structure. The battery could be attached to the frame in a number of ways. The battery could be included as part of a leg weight as described above, with a cable that connects the battery to the rest of the electrical system. The battery could also have its own mount that is affixed to the frame of the structure.

The electrical system can include standard ports, such as USB ports, and depending on the battery capacity, could potentially include a standard 12V electric outlet.

The electrical system can also contain custom ports. These ports should be compatible with the collapsing structure and require minimum setup/breakdown. These custom ports would provide both an electrical connection as well as the structural support for components that plug into them, such as lights, speakers, or fans. This type of support is maximally easy to use, requiring only to insert the desired component, which is then powered and held in place appropriately, as opposed to dealing with wires and clamping a component to the structure in some other manner.

The electric system could also be compatible with a solar panel system, ensuring that the battery is able to be charged while the structure is in use.

While lighting could be plugged into the standard or custom ports, it could also be integrated into the metal frame, or sewn into the canopy roof.

In some embodiments, an add-on system can be provided for a temporary structure such as a popup canopy tent that improves upon the rain handling of a temporary structure. Proper rain handling is commonly an issue with temporary structures—the rain collects on the roof and cascades over the edges of the tent, often where customers are standing or where the vendor's goods might be on display. It would be beneficial to more effectively direct the water off of the roof of the structure. Below is described a method of doing so by modifying an existing tent with an add-on gutter. The add-on gutter can be affixed to an existing tent which will then properly route the water to the corners of the tent, avoiding the cascading water issue described above.

Previous art of an add-on gutter can only be used when two tents are adjacent and the gutter joins between them with the desired outcome only to prevent water from cascading between the two tents. The add-on gutter disclosed herein improves on two components—1) it can be affixed to a single tent and 2) it need only be installed one time, after which it is compatible with the collapsing and erecting of the structure.

To only be installed once, it can be of malleable material that can collapse when the structure is collapsed. In this example, it could be a water-resistant cloth material. Shaped like a long strip of fabric, it can create a U shape that provides a cupping strip of fabric beneath the edge of the piece of fabric that comprises the roof of the structure. Water will cascade over the edge of the tent, but then be caught in this U-shaped length of fabric, which is then angled towards the corners of the tents, where there is an exit for the water to run down the legs of the structure.

This U-shaped piece of fabric must stay in place and maintain its shape. It will be taut around the corners of the structure, and will affix to the frame in some manner, such as a hook and loop fastener (i.e., Velcro®) or clips. It could maintain its shape by having some rigid pieces in it, that, combined with the tension created from the corners of the tent, will keep its U-shaped cup that catches and routes the water.

This add-on gutter system could be combined with the wiring system from the electric system described above or with a sign or an awning that connects to the temporary structure.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

With regard to the above detailed description, like reference numerals used therein may refer to like elements that may have the same or similar dimensions, materials, and configurations. While particular forms of embodiments have been illustrated and described, it will be apparent that various modifications can be made without departing from the spirit and scope of the embodiments herein. Accordingly, it is not intended that the invention be limited by the forgoing detailed description.

The entirety of each patent, patent application, publication, and document referenced herein is hereby incorporated by reference. Citation of the above patents, patent applications, publications and documents is not an admission that any of the foregoing is pertinent prior art, nor does it constitute any admission as to the contents or date of these documents.

Modifications may be made to the foregoing embodiments without departing from the basic aspects of the technology. Although the technology may have been described in substantial detail with reference to one or more specific embodiments, changes may be made to the embodiments specifically disclosed in this application, yet these modifications and improvements are within the scope and spirit of the technology. The technology illustratively described herein may suitably be practiced in the absence of any element(s) not specifically disclosed herein. The terms and expressions which have been employed are used as terms of description and not of limitation and use of such terms and expressions do not exclude any equivalents of the features shown and described or portions thereof and various modifications are possible within the scope of the technology claimed. Although the present technology has been specifically disclosed by representative embodiments and optional features, modification and variation of the concepts herein disclosed may be made, and such modifications and variations may be considered within the scope of this technology.

1. A system for securing or suspending objects from a vertical post or structural leg of a structure, comprising:
a clamp comprising an outer grip and an inner grip defining a space therebetween sized to accommodate the vertical post or structural leg, the clamp configured to grip the vertical post or structural leg by creating frictional contact through applied torque; and
a weight configured to be connected to the clamp to generate the torque on the clamp necessary for the clamp to grip the vertical post or structural leg.

2. The system of claim 1, wherein the weight comprises a rolltop bag capable of variable compression to accommodate different fill levels of a substance within the rolltop bag.

3. The system of claim 1, wherein the clamp comprises a single bent rod forming the outer grip, inner grip, and a connecting section configured to connect the clamp to the weight.

4. The system of claim 1, wherein the outer grip and inner grip are coated with a material having a high friction coefficient to ensure secure gripping of the vertical post of structural leg.

5. The system of claim 1, further comprising a handle connected to the clamp and the weight to facilitate carrying and manipulating the system during mounting and dismounting.

6. The system of claim 5, wherein the clamp is configured such that the outer grip is positioned higher than the inner grip when a handle is parallel to the ground.

7. The system of claim 5, further comprising D-rings integrated into the weight that click into the handle to secure a connection between the handle and the weight.

8. The system of claim 1, wherein the clamp includes adjustable elements to accommodate vertical posts or structural elements of varying sizes.

9. The system of claim 1, wherein the weight and the clamp are interconnected using a flexible strap to allow mounting at variable heights along the vertical post or structural leg.

10. The system of claim 1, further comprising a tensioned loop below the clamp configured to supplement the torque applied by the weight for gripping the vertical post or structural leg.

11. The system of claim 1, wherein the weight comprises modular sections attachable to one another to adjust the torque generated by the weight.

12. The system of claim 1, wherein the weight is configured to anchor a temporary structure to the ground by applying torque through the clamp to a structural leg.

13. The system of claim 1, wherein the clamp is configured to be initially positioned on the vertical post or structural leg in a first orientation and the torque generated by the weight causes the clamp to transition to a second orientation.

14. A leg weight system for securing a temporary structure to the ground, comprising:
a weight configured to apply a downward force; and
a clamp comprising an outer grip and an inner grip defining a space therebetween sized to accommodate a structural leg of the temporary structure, the clamp configured to grip the structural leg of the temporary structure by creating frictional contact through torque applied by the downward force of the weight,
wherein the weight is configured to anchor the temporary structure by applying torque through the clamp to provide the downward force to the structural leg.

15. The leg weight system of claim 14, further comprising a handle interconnected with the weight and the clamp to facilitate carrying and mounting.

16. The system of claim 15, wherein the clamp is configured such that the outer grip is positioned higher than the inner grip when the handle is parallel to the ground.

17. The system of claim 15, further comprising D-rings integrated into the weight that click into the handle to secure a connection between the handle and the weight.

18. The system of claim 14, wherein the clamp is configured to be initially positioned on the vertical post or structural leg in a first orientation and the torque generated by the weight causes the clamp to transition to a second orientation.

19. The system of claim 14, wherein the weight comprises a rolltop bag capable of variable compression to accommodate different fill levels of a substance within the rolltop bag.

20. The system of claim 14, wherein the clamp comprises a single bent rod forming the outer grip, inner grip, and a connecting section configured to connect the clamp to the weight.

21. The system of claim 14, wherein the outer grip and inner grip are coated with a material having a high friction coefficient to ensure secure gripping of the structural leg.
